(19) United States
(12) Patent Application Publication
(10) Pub. No.: US 2008/0299531 A1
(43) Pub. Date: Dec. 4, 2008

(54) System And Method For Training Employee

(76) Inventor: Jennifer C. Jensen, Tacoma, WA (US)

Correspondence Address: HARSHAW RESEARCH, INC., 210 W. TECUMSEH STREET, OTTAWA, KS, 66067, US

(21) Appl. No.: 11/757,524

(22) Filed: Jun. 4, 2007

(51) Int. Cl. G09B 7/00

(52) U.S. Cl. 434/335

(57) ABSTRACT

A system and method of training a plurality of employees includes a handheld device having a display, an input, and a processor in data communication with the display and input. The processor includes programming for actuating the display to ask the employees a plurality of questions and to record answers entered through the input. The method further includes having the employees answer questions and includes reviewing the answers to the questions. The handheld device may include a receiver and the programming may be delivered to the processor using a transmitter. Alternatively, the programming may be placed on a memory device and the memory device may be placed in data communication with the processor. Further, the step of reviewing the answers to the questions may include having a machine score at least one answer and having a person consider at least one answer.

### BACKGROUND OF THE INVENTION

The present invention relates generally to an electronic game and, more particularly, to a system and method for training employees using an electronic game interface.

A difficult problem experienced especially by large companies is the process of continuing education for its employees. The need for continuing education for employees may be ever-changing levels of technology, employees changing job roles, or establishment of new company procedures to foster increased efficiency or profitability.

One problem experienced by companies attempting to facilitate job training is motivating employees to participate fully in a prescribed training program. Another problem is finding a training program that is fun and exciting yet very effective. Still another problem for a company is finding a generic game that may be customizable to the specific needs of the company, its employees, and training objectives.

Various training programs, books, and even games are available on the market or have been proposed in the prior patents. Although assumably effective for their intended purposes, the existing devices or methods are not fully effective for one or more of the reasons discussed above.

Therefore, it would be desirable to have a method for training an employee that provides a handheld device that may be customized by an administrator. Further, it would be desirable to have a method for training an employee that includes multiple selectable and entertaining game modes. In addition, it would be desirable to have a method for training an employee in which answers to questions may be partially scored by a computer and partially reviewed or scored by a person such as a supervisor or manager.

### SUMMARY OF THE INVENTION

A method of training a plurality of employees includes a handheld device having a display, an input, and a processor in data communication with the display and input. The processor includes programming for actuating the display to ask an employee a plurality of questions and to record answers entered through the input. The method further includes having the employee answer questions and includes reviewing the answers to the questions. The hand held device may include a receiver and the programming may be delivered to the processor using a transmitter. Alternatively, the programming may be placed on a memory device and the memory device may be placed in data communication with the processor. Further, the step of reviewing the answers to the questions may include having a machine score at least one answer and having a person consider at least one answer.

An administrator may customize the questions to be presented by the handheld device. Topics forming the basis for questions may include Efficiency, Teamwork, Production/Manufacturing, Communication, Administration, Human Resources, Waste, Safety, Sales and Marketing, Cost and Expenses, Inventory, Purchasing, Shipping/Receiving, Quality, Cleanliness and Organization, Internal customer service, External customer service, Earnings, Company policy and philosophy, Company programs, Advertising, and Turnover.

Employees may be requested or required to answer questions using the handheld device. There are many game categories or modes for encouraging employees to participate and for motivating thoughtful responses. Ultimately, answers to questions may be scored by a computer or considered subjectively by a manager. Awards may be given for best scores.

Therefore, a general object of this invention is to provide a system and method for training employees that provides an electronic handheld device by which employees may answer questions customized by an administrator.

Another object of this invention is to provide a system and method, as aforesaid, which motivates and encourages participation through multiple selectable game modes.

Still another object of this invention is to provide a system and method, as aforesaid, in which answers to questions may be scored by a computer or through consideration by an administrator.

Yet another object of this invention is to provide a system and method, as aforesaid, that enables customized game questions to be delivered to the handheld device using a transmitter or a memory device.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a handheld device according to a preferred embodiment of the present invention;

FIG. 2 is a block diagram illustrating the electronic components of the present invention;

FIG. 3 is a flowchart illustrating the steps of the inventive methodology according to the present invention; and

FIG. 4 is another flowchart illustrating the steps of the inventive methodology.

### DESCRIPTION OF THE PREFERRED EMBODIMENT

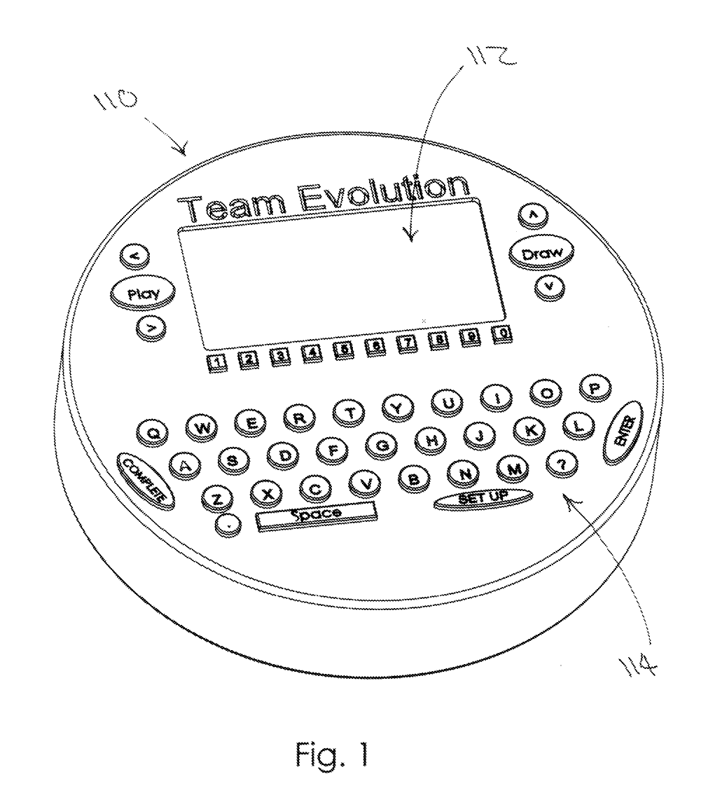

A system 100 and a method 200 for employee training according to the present invention will now be described in detail with reference to FIGS. 1 through 4 of the accompanying drawings. More particularly, a system 100 for employee training according to the current invention includes a handheld device 110.

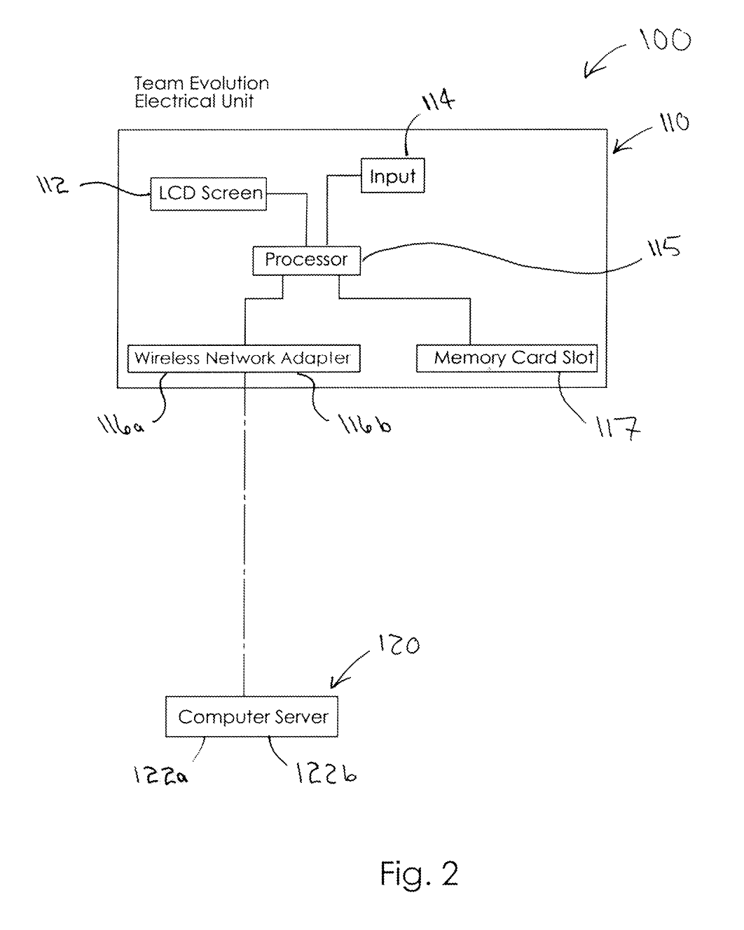

As shown in FIGS. 1 and 2, the handheld device 110 has a display 112 (e.g., any visual and/or audible display), an input 114 (e.g., a keyboard, input buttons, touch screen, etc.), and a processor 115 in data communication with the display 112 and the input 114. The processor 115 includes programming as discussed in detail below. The handheld device 110 may additionally include a transmitter 116a, a receiver 116b, and/or an interface 117 for receiving a removable memory device (i.e., a memory card slot, a cd reader, a floppy disc reader, etc.) in data communication with the processor 115. The transmitter 116a and the receiver 116b may or may not utilize wireless technology.

A remote computer 120 (FIG. 2) may be included that has hardware (e.g., a cd writer, a floppy disc writer, or any other type of data writing device) for placing the programming on the removable memory device for use with the interface 117. Alternately (or additionally), the remote computer 120 may include a transmitter 122a and receiver 122b for communicating with the transmitter 116a and the receiver 116b of the handheld device 110. Communication between the handheld device 110 and the remote computer 120 may allow the remote computer 120 to provide the programming to the handheld device 110 and/or the handheld device 110 to provide the remote computer 120 data as discussed further below. It should be appreciated that while various devices are described herein for providing the programming to the handheld device 110, the programming may alternately be provided or updated using the handheld device 110 without the remote computer 120, and that data may be maintained in the handheld device 110.

The programming in the processor 115 includes instructions for actuating the display 112 to ask employees a plurality of questions and to record answers entered through the input 114. The programming may include instructions for having each employee enter an identification code (e.g., a user name and/or password) before using the input 114 to enter the answers, instructions for scoring all of the answers entered through the input 114, instructions for scoring at least one answer but less than all of the answers entered through the input 114, and/or instructions for sending answers to the remote computer 120 (i.e., using the transmitter 116a) so that the remote computer 120 or an administrator may score the answers.

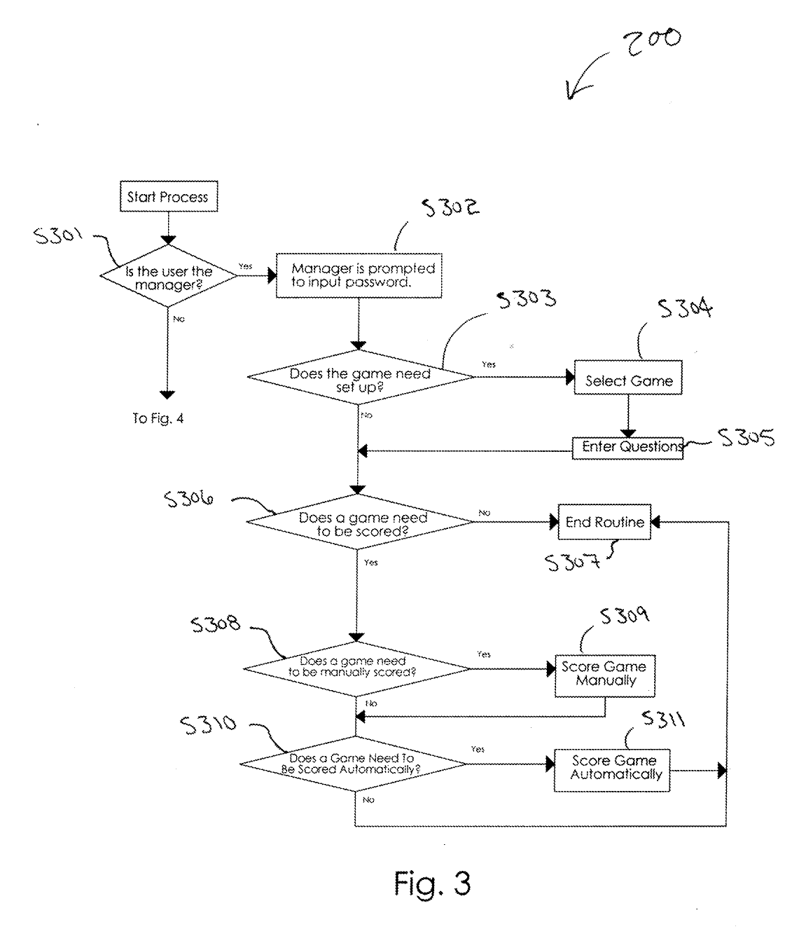

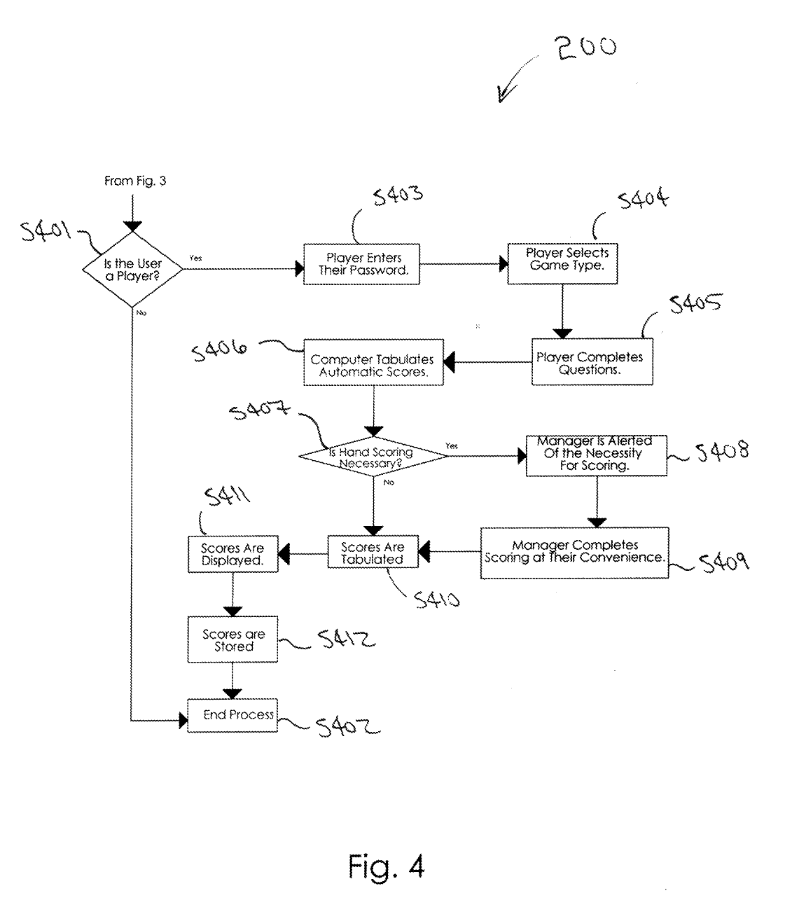

FIGS. 3 and 4 illustrate portions of the method 200 for employee training according to an embodiment of t he present invention. At step S301, the system 100 (e.g., the processor 115 or the remote computer 120) determines if a user is a manager (also referred to herein as “administrator”). This may be done, for example, by having the userenter a username or simply input data asserting that he is an administrator and processing that data. If the user is an administrator, the method proceeds to step S302; if not, the method proceeds to step S401.

At step S302, the administrator may be required to input a password to confirm his status as an administrator. Once the status is confirmed, the method proceeds to step S303. Notably, the administrator may be using the input device 114 or the remote computer 120. If using the remote computer 120, information may be exchanged with the handheld device 110 as discussed in more detail below by using the hardware for placing the programming on the removable memory device or the transmitter 122a and receiver 122b.

At step S303, the system 100 (e.g., the processor 115 or the remote computer 120) determines if a game (series or groups of questions may be referred to herein as a “game”) needs to be set up. This may be done, for example, by having the user input data directed to whether a game needs to be set up and processing that data. If a game needs to be set up, the method proceeds to step S304. If not, the method proceeds to step S306.

At step S304, the administrator selects a game, for example, by using the input device 114 or the remote computer 120. Once a game is selected, the method proceeds to step S305 where the administrator enters a plurality of questions for the selected game. One exemplary game is titled “All For One” and requires that all players answer a question, participate in a task, or engage in an exercise pertaining to a specific subject. All players who participate in a task receive points for doing so, and players who do not participate forfeit their points (for example to a player who picked the specific subject). The All For One game may improve teamwork, involvement, interaction, camaraderie, team communication, strategy, peer pressure, constructive feedback, motivation, and/or problem solving. An exemplary question for the All For One game is: “Name one thing you would really appreciate someone else's assistance with regarding your job and why.”

Another exemplary game is titled “Two To Tango” and requires that a player team up with another player to complete a mission. Both players must participate in order to receive points. The Two To Tango game may broaden interaction, provide hands on training, initiate role-playing/role-reversals, encourage healthy competition, facilitate one on one communication and mentoring, and/or improve teamwork. Exemplary questions for the Two To Tango game present tasks, role-playing situations, training opportunities, an chances to open the lines of communication between two teammates regarding a particular subject.

Another exemplary game is titled “Trivia” and requires players to answer questions pertaining to particular subjects. Players may be given the choice of answering the question immediately of delaying so research can be performed; delayed answers may be worth fewer points than immediate answers. The Trivia game may provide product knowledge, process knowledge, company knowledge, subject knowledge, and/or teach players to think on their feet. An exemplary question for the Trivia game is: “What is our company slogan?”

Another exemplary game is titled “Forms & Procedures” and requires players to participate in a task in order to learn more about a particular subject. Point may be awarded once the task is complete. The Forms & Procedures game may allowing mentoring, “out of the box” training, and/or provide company knowledge. Exemplary questions for the Forms & Procedures game are tasks that require players to learn about different forms of paperwork that they may not be familiar with, proper documentation procedures, or any other task that they may not be required to do on an everyday basis but should ultimately know. An exemplary question for the Forms & Procedures game is: “Under what circumstance would you fill out and submit a ______ form?”

Another exemplary game is titled “Scavenger” and requires players to find information or answer riddles about a particular subject. Correct answers may be awarded points. The Scavenger game may promote and improve interaction, effective communication, drive root cause analysis, follow through, problem solving, company wide personnel and position knowledge, and comfort zone expansion. Exemplary questions for the Scavenger game are tasks that require the user to go “outside of the box” to obtain information regarding a particular subject. An exemplary question is: “Find out how much costs and how many we go through in a month.”

Another exemplary game is titled “Scruples” and requires players to state opinions or make decisions when faced with specific scenarios regarding a particular subject. The players may be required to support their opinions/decisions with facts, experiences, and/or reasoning. Points may be awarded for participation or for answer quality. The Scruples game may allow for coaching and leadership training, promote involvement, productive conflict, role-playing, communication, and/or convictions. Exemplary questions for the Scruples game place players in the middle of various points of view (e.g., management, customers, general employees, etc.) regarding a particular subject. An exemplary question is: “You are in charge. Two employees are not getting along, and it is affecting the morale and productivity of the team. This cannot continue. How do you handle the situation?”

As noted above, the game selection and the questions may be provided using the input device 114 or by using the remote computer 120 with the transmitter or the data writing device in conjunction with the receiver 116b or the interface 117 of the handheld device 110. The method proceeds from step S306 to step S306.

At step S306, the system 100 (e.g., the processor 115 or the remote computer 120) determines if a game needs to be scored. This may be done, for example, by determining if answers have been entered since a game was previously scored. If not, the method may end at step S307. If so, the method proceeds to step S308.

At step S308, the system 100 (e.g., the processor 115 or the remote computer 120) determines if a game needs to be scored manually. If the remote computer 120 is used to review the answers provided through the input device 114, the transmitter 116a may send the answers to the remote computer 120. A game may need to be scored manually, for example, if the answers to the questions were not in the form of multiple-choice answers. If not, the method proceeds to step S310. If so, the method proceeds to step S309, where the administrator scores the answers manually, and the method then continues to step S310.

At step S310, the system 100 (e.g., the processor 115 or the remote computer 120) determines if a game needs to be scored automatically. A game may need to be scored automatically, for example, if the answers to the questions were in the form of multiple-choice answers or otherwise subject to automated scoring. If not, the method ends at step S307. If so, the method proceeds to step S311, where the system 100 (e.g., the processor 115 or the remote computer 120) scores the answers automatically, and the method then ends at step S307. Notably, some answers may be scored automatically while others are scored manually. In addition, before the method ends at step S307, the administrator may reward the employee that did the best job in providing one or more answer (i.e., the employee whose answer or answers achieved the best score of those participating).

At step S401, the system 100 (e.g., the processor 115 or the remote computer 120) determines if a user is a player (also referred to herein as “employee” and “participant”). This may be done, for example, by having the user enter a username or simply input data asserting that he is a player and processing that data. If the user is a player, the method proceeds to step S403; if not, the method ends at step S402.

At step S403, the player may be required to input a password (e.g., an identification code, etc.) using the input device 114 to confirm his status as an employee. Once the status is confirmed, the method proceeds to step S404.

At step S404, the player may select a game to play and/or a difficulty level of a question to be answered. The method proceeds to step S405.

At step S405, the player answers at least one question using the input device 114. The player may further be required to transfer the handheld device 110 to another employee to allow that employee to also provide at least one answer using the input device 114. If the handheld device 110 is transferred, the latter employee may be required to return to step S401, for example. The method continues from step S405 to step S406.

At step S406, the system 100 (e.g., the processor 115 or the remote computer 120) scores the answers automatically, and the method proceeds to step S407. If the remote computer 120 is used to review the answers provided through the input device 114, the transmitter 116a may send the answers to the remote computer 120.

At step S407, the system 100 (e.g., the processor 115 or the remote computer 120) determines if a game needs to be scored manually. If the remote computer 120 is used to review the answers provided through the input device 114, the transmitter 116a may send the answers to the remote computer 120. A game may need to be scored manually, for example, if the answers to the questions were not in the form of multiple-choice answers. If not, the method proceeds to step S410. If so, the method proceeds to step S408, where the administrator is alerted of the necessity for manual scoring, and the method then continues to step S409. At step S409, the administrator scores at least one answer manually. See step S309. The method then proceeds to step S410.

At step S410, the scores for the answers may be tabulated, and the method may then proceed to step S411 where the scores are displayed. The scores may be displayed on the portable device display 112, on a bulleting board, through email, or in any other appropriate manner. As noted in step S310, the administrator may reward the employee that did the best job in providing one or more answer (i.e., the employee whose answer or answers achieved the best score of those participating). From step S411, the method proceeds to step S412, where the scores may be stored as part of employees' records or otherwise stored for future reference. The method proceeds from step S412 to step S402, where the method ends.

It is understood that while certain forms of this invention have been illustrated and described, it is not limited thereto except insofar as such limitations are included in the following claims and allowable functional equivalents thereof.

1. A method of training a plurality of employees, said method comprising:
providing a handheld device having a display, an input, and a processor in data communication with said display and said input;
providing programming to said processor for actuating said display to ask said employees a plurality of questions and to record answers entered through said input;
having said employees answer said questions using said input; and
reviewing said answers provided through said input.

2. The method as in claim 1, wherein:
said handheld device has a receiver; and
said step of providing programming comprises using a transmitter to send said programming to said receiver.

3. The method as in claim 1, wherein said step of providing programming comprises placing said programming on a memory device and placing said memory device in data communication with said processor.

4. The method as in claim 1, wherein said step of reviewing said answers includes having a machine score at least one said answer and having a person consider at least one other said answer.

5. The method as in claim 1, wherein:
said handheld device has a transmitter; and
said step of reviewing said answers includes using said transmitter to send said answers to a remote computer.

6. The method as in claim 1, wherein said step of having said employees answer said questions includes having a first said employee answer at least one said question using said input, having said first employee transfer said handheld device to a second employee, and having said second employee answer at least one said question using said input.

7. The method as in claim 1, wherein said step of having said employees answer said questions includes having each said employee enter an identification code before using said input to enter said answers.

8. The method as in claim 1, wherein said step of reviewing said answers includes:
determining which said employee did a best job in providing at least one said answer; and
rewarding said employee which did a best job in providing at least one said answer.

9. The method as in claim 8, wherein said step of determining which said employee did a best job in providing at least one said answer includes having a machine score at least one said answer and having a person consider at least one other said answer.

10. The method as in claim 9, wherein:
said handheld device has a receiver; and
said step of providing programming comprises using a transmitter to send said programming to said receiver.

11. The method as in claim 9, wherein said step of providing programming comprises placing said programming on a memory device and placing said memory device in data communication with said processor.

12. The method as in claim 9, wherein:
said step of having said employees answer said questions includes having a first said employee answer at least one said question using said input, having said first employee transfer said handheld device to a second employee, and having said second employee answer at least one said question using said input; and
said step of having said employees answer said questions includes having each said employee enter an identification code before using said input to enter said answers.

13. A system for employee training, said system comprising:
at least one handheld device having a display, an input, and a processor in data communication with said display and said input;
programming in said processor for actuating said display to ask said employees a plurality of questions and to record answers entered through said input; and
a remote computer.

14. The system as in claim 13, wherein:
said handheld device has a receiver; and
said remote computer has a transmitter to send said programming to said receiver.

15. The system as in claim 13, wherein said programming includes instructions for scoring at least one said answer.

16. The system as in claim 13, wherein said programming in said processor includes instructions for having each said employee enter an identification code before using said input to enter said answers.

17. The system as in claim 13, wherein said remote computer includes means for scoring at least one said answer.

18. The system as in claim 17, wherein:
said handheld device has a transmitter; and
said means for scoring at least one said answer includes a receiver for receiving at least one said answer from said transmitter.

19. A system for employee training, said system comprising:
at least one handheld device having a display, an input, and a processor in data communication with said display and said input;
programming in said processor for actuating said display to ask said employees a plurality of work-related questions and to record answers entered through said input, said programming including instructions for having each said employee enter an identification code before using said input to enter said answers.

20. The system as in claim 19, wherein said programming includes instructions for scoring at least one said answer but less than all said answers
